(19) United States
(12) Patent Application Publication
(10) Pub. No.: US 2026/0178641 A1
(43) Pub. Date: Jun. 25, 2026

(54) Apparatus for Extracting Technical Parameters and Functional Characteristics from Project Information and a User Interface Apparatus

(71) Applicant: KONE CORPORATION, Helsinki (FI)

(72) Inventors: Emilia Blomfelt, Espoo (FI); Henri Sainio, Espoo (FI); Kristof D'Argent, Espoo (FI)

(73) Assignee: KONE CORPORATION, Helsinki (FI)

(21) Appl. No.: 18/989,717

(22) Filed: Dec. 20, 2024

(51) Int. Cl. G06F 16/34; G06F 40/279

(52) U.S. Cl. CPC G06F 16/345; G06F 40/279

(57) ABSTRACT

An apparatus for extracting technical parameters and functional characteristics from project information includes processing circuitry configured to receive project information related to a requested project for a building access hardware, the project information including technical parameters and functional characteristics of the requested project, process the received project information using a machine learning model to extract the technical parameters and functional characteristics from natural language in the received project information, and generate a project recommendation based on the extracted technical parameters and functional characteristics, the project recommendation including one or more candidate projects related to the building access hardware, the project recommendations based on the technical parameters and functional characteristics to the building access hardware included in the project information.

### BACKGROUND

When tendering services to a client, a service provider will request information from the client. Generally, a client will provide information to the service provider which the service provider compares to parameters of services which the service provider can provide. The service provider then tenders an offer to the client based on services which the service provider can provide, and the information provided by the client. For services related to building access hardware, such as elevators, escalators, moving walkways, and access gates, this process can be more complex than for other services because there can be regulations related to these types of hardware and services which are location specific.

This process takes up a considerable amount of time for both the service provider and the client, especially for new clients which may not be familiar with the services which the service provider can provide or the local regulations. There have been some attempts to automate this process by using very restrictive computer forms where the client can fill in certain fields. This very rigid process can be helpful for simple services such as modernizing of a control panel for an elevator. However, for more complicated services, such as replacing an elevator system in a building, with tradeoffs and complex parameters, this rigid approach does not improve the time for tendering the services.

### SUMMARY

Example embodiments of the present disclosure relate to an apparatus for extracting technical parameters and functional characteristics from project information and a user interface apparatus. The example embodiments improve the speed and ease of tendering services to clients. These improvements come from several improvements in the below described Example embodiments. Some of these improvements include the recognition of natural language in submitted client information which allows the service to be performed without rigid forms. The training of a large language model on information (including documents and files) related to the provided services for improved recognition of parameters related to the services which can be tendered. A user interface which presents candidate projects to a user of the user interface and receives feedback from the user before generating a project summary so that user input can improve the project summary. The large language model may also be trained with the input from the user for improved future performance of the large language model.

In an example embodiment, an apparatus for extracting technical parameters and functional characteristics from project information is provided. The apparatus includes processing circuitry configured to receive project information related to a requested project for a building access hardware, the project information including technical parameters and functional characteristics of the requested project, process the received project information using a machine learning model to extract the technical parameters and functional characteristics from natural language in the received project information, and generate a project recommendation based on the extracted technical parameters and functional characteristics, the project recommendation including one or more candidate projects related to the building access hardware, the project recommendations based on the technical parameters and functional characteristics to the building access hardware included in the project information.

In another example embodiment a user interface apparatus is provided. The user interface apparatus includes a user input and output interface, and processing circuitry. The processing circuitry is configured to receive project information related to a requested project for a building access hardware, the project information including technical parameters and functional characteristics of the requested project, extract the technical parameters and functional characteristics of the requested project to the building access hardware, generate a project recommendation list based on the extracted technical parameters and functional characteristics, the project recommendation list including one or more candidate projects related to the building access hardware, the project recommendations based on the technical parameters and functional characteristics included in the project information, provide the project recommendation list to a user via the user input and output interface, receive a selection of one of the one or more candidate projects related to the building access hardware from the user via the user input and output configuration, and generate a project summary based on the selected one of the one or more candidate projects related to the building access hardware.

In another example embodiment an apparatus for extracting technical parameters and functional characteristics from project information is provided. The apparatus including processing circuitry configured to receive project information related to a requested project for a building access hardware, the project information including technical parameters and functional characteristics of the requested project, process the received project information using a machine learning model to extract the technical parameters and functional characteristics from natural language in the received project information, wherein the machine learning model is trained on a library of previous project information and previous project summaries related to building access hardware, generate a project summary based on the extracted technical parameters and functional characteristics, the project summary including one of the one or more candidate projects related to the building access hardware, and update the machine learning model by updating the previous project information with the project information, updating the previous project summaries with the project summary, and training the machine learning model using the updated previous project information and the updated previous project summaries.

### BRIEF DESCRIPTION OF THE DRAWINGS

The drawings illustrate example embodiments which provide improvements over the prior art. The drawings include the following:

FIG. 1 illustrates an example of a display on a display screen which is part of a user interface;

FIG. 2 illustrates a user device and a client device which may communicate with each other;

FIG. 3 illustrates a flow diagram of operations performed by the apparatus to extract technical parameters and functional characteristics from project information;

FIG. 4 illustrates a flow diagram of operations performed by the user interface apparatus;

FIG. 5 illustrates a flow diagram showing an example flow of information in an apparatus; and

FIG. 6 illustrates a flow diagram showing an example flow of information in extracting parameters from tenders.

### DETAILED DESCRIPTION OF THE DRAWINGS

The detailed description of the drawings provides example embodiments which illustrate advantages over the prior art. The example embodiments should not be interpreted as exclusive. The example features described below should not be interpreted as necessary features unless expressly described as such.

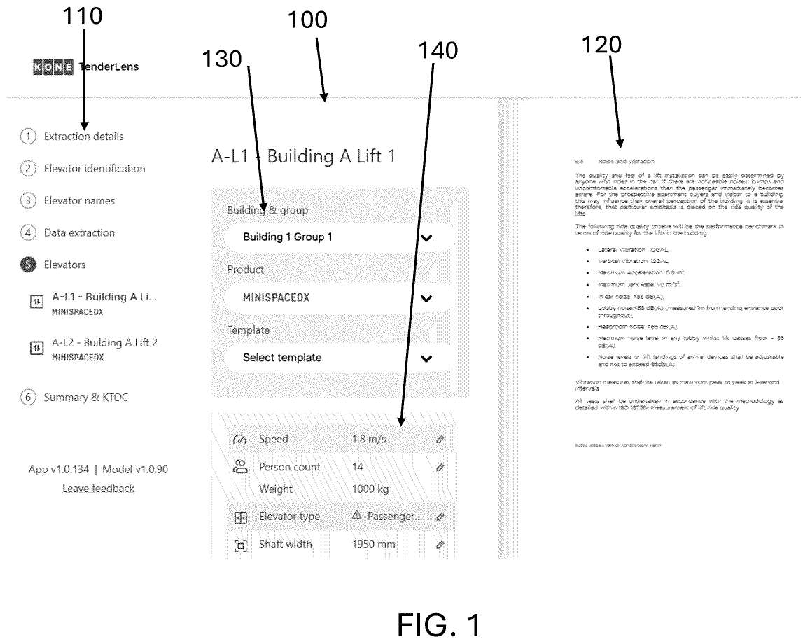

FIG. 1 illustrates an example of a display 100 on a display screen which is part of a user interface. The display 100 may include an operations list 110, a display of client provided information window 120, and an operation specific window 130 which may include a parameter list 140. The display screen may be part of a display hardware such as touch screen or monitor which will be described in greater detail below.

The operations list 110 may include operations such as extraction details, elevator identification, elevator names, data extraction, elevators, and project summary. For extraction details a user of the user interface may provide client information (project information) in the form of documents, emails, schematics, etc. to a data extraction program. For example, by dragging and dropping files into a document retrieval window included in the operation specific window 130 when the extraction detail operation is selected. The user may also provide an input such as text or a selection from a drop-down menu to prompt the program. For example, an input of “installation of elevators in a new building,” could be input by the user. The prompt may be optional, the large language learning model may be capable of determining what the appropriate candidate elevator for installation (or other services or installations) are based on the inputted client provided information alone. The large language learning model may be implemented as a machine learning model. As an example, the machine learning model may include multiple layers of trained neural nodes. The neural nodes may be organized to form a feed forward neural network. Machine learning model may refer to any form of trained or untrained neural network, generative AI, artificial intelligence, or other similar computer implemented tool for learning or pattern recognition.

After the user has input the client provided information and/or the prompt, the program may extract technical parameters and functional characteristics from the client provided information. For example, the program may extract parameters by creating vectors for each of a plurality of possible parameters and determining what information in the client provided information relates to each of these vectors based on the training of the large language model. As a simple example, the large language model may determine that a first vector related to a desired service or installation being elevator related has a high value if each of the client provided information files includes the word “elevator.” The large language model may also determine values for vectors related to elevator installation based on recognized words and numbers related to the elevators. Having a large language model trained specifically on documents related to building access hardware may be advantageous because words like “car” are often used in these documents to discuss elevator cars. A large language model trained on general use of the word “car” may struggle identifying that this word relates to elevators because the word “car” is more commonly used to refer to automobiles in general communications.

The extracted technical parameters and functional characteristics may be used to identify the building access hardware which needs installing. For example, the program may determine that there are two elevators that need installation. This may be displayed in the operation specific window 130. The program may display one or more identified portion of the user provided information as well to assist the user in confirming the program has correctly identified the needed installations. For example, the program may display a portion of the user provided information, which is a project request document written in natural language (e.g., how a person would speak), that includes a description of a need for replacing two elevators in a building. The program may add highlights to this section of the project information in the client provided information window 120 to improve identifiability for the user. The user may provide an input to confirm that the program has correctly identified the building access hardware which needs servicing.

After the input is confirmed or after a predetermined time, the program may proceed to an operation for naming the building access hardware. The program may suggest names such as “building A lift 1” or building A lift 2.” The user may change the names or provide an input confirming the suggested names. The suggested names may be names included in the client provided information. For example, if the user referred to one elevator as “north elevator” and one elevator as “south elevator” the program may suggest these names. The program may again display relevant portions of the client provided information documents in the client provided information window 120.

After the user has provided input, or after a predetermined time, the program may proceed to an operation of data extraction. The large language learning model may be used to extract information and organize the information for each individual hardware of the building access hardware. For example, dimensions of each elevator shaft and elevator car, dimensions of elevator door openings in the elevator shaft, desired speed for each elevator, desired weight capacity, location of the building including the building access hardware, relevant regulations based on the location of the building, elevator type (e.g., passenger or freight), etc. If no information can be detected related to a parameter, the program may leave a parameter blank or may prompt a user to enter a value for this parameter. This may be done by a user contacting the client to obtain more information using the program or separately. For some parameters the program may be able to make inferences such as inferring a range of sizes of an opening in the elevator shaft for the elevator doors based on a date the building was built and the regulations for the building based on the date the building was built. Information that was determined based on inference and not based on information from the client provided information may be indicated as such in the parameter display area 140.

The user may confirm the extracted parameters by reviewing the displayed user provided information in the user provided information window 120 and comparing the user provided information to the parameters provided by the program in the operation specific window 130. The program may also use ranges for technical parameters and functional characteristics. For example, a functional characteristic may be “over 1000 pounds carrying capacity,” or “speed of 1 m/s-2 m/s.” As another example, a technical parameter may be “150 cm width elevator shaft.”

After the user has provided input or after a predetermined time, the program may proceed to providing candidate projects to the user. The candidate projects may be provided in a drop-down menu or form of display. When a candidate project is selected the parameter display area 140 may display the specific parameters of the candidate project. The building access equipment which needs installation can also be selected in a drop-down menu so that the user can see the candidate projects for each building access hardware with requested installation or service. The user may provide an input of a selection or a confirmation. The list of candidate installation for each building access hardware may be organized in a ranking, for example a candidate projects with parameters that meet, match, or are similar to all of the technical parameters and functional characteristics may be on top of the list and candidate installation that do not meet all parameters may be listed below. When a candidate project is selected that does not meet all the parameters. The parameters which are not met may be displayed with an icon indicating a parameter which is not met. If the technical parameters or functional characteristics are outside of the legal regulations for an area that may also be indicated with a symbol indicating that special permitting may be required. The list of candidate project may be listed with candidate projects which meet all regulations above candidate projects that do not meet all legal regulations. The list may also be ranked in any number of other ways, such as by weight capacity, reliability, speed, availability of components, projected installation time, etc.

After the user has provided an input or after a predetermined time, the program may continue to provide a summary of the selected project which may be included in a tendering document. The user may review the project summary and/or tendering document and confirm the that the project summary and/or tendering document is acceptable. The program may then provide the project summary and/or tendering document to the user. In some example embodiments, the program may transmit the document to the client via email, a web application or other similar electronic communication.

In some example embodiments, the process of generating the project summary and/or tendering document may be completely automated so that user input is not needed. In some example embodiments, the program may transmit a request for project information to the client and receive the project request documents directly without user interaction. In some example embodiments, the summary for each building access equipment may be generated individually, while in other example embodiments, the summary for all of the building access equipment may be generated at the same time (e.g., the user provides input at each step of the program for all building access hardware with requested project before proceeding to the next step). In yet another example embodiment, the summary for different types of building access hardware are done separately (e.g., a summary for elevators is generated before the process for access gates is performed).

The display 100 may also include a chat feature where a user of the program can chat with a client or other user. The chat may be used to request clarifications for the client on information included in the documents or preferences for certain features. A resultant chat thread may be used to train the LLM for improved future project suggestions.

The display 100 may also include a reference library live feature where a user can see references such as previous orders, previous project summaries, previous tender documents, or other similar documents. The reference library live feature may include a pop-up window that displays a list of previous references. When a reference is selected it may be displayed in the client provided information window 120 or in another location. Selections of building access equipment from the reference may also be displayed with the candidate projects. Consequently, the building access equipment from the reference for a current project summary may be selected by the user if desired.

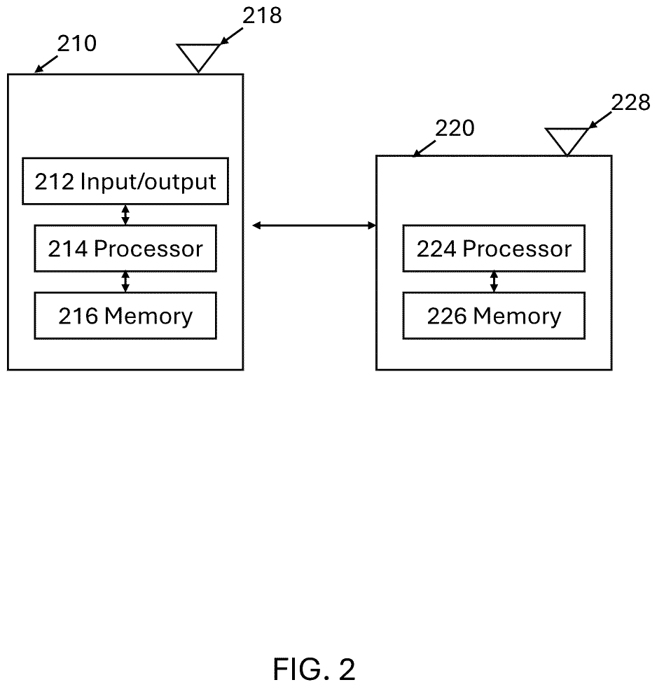

FIG. 2 illustrates a user device 210 and a client device 220 which may communicate with each other. The user device may be a personal computer, smartphone, server, group of processing devices, etc. The user device 210 may include input and output hardware 212 a processor 214, a memory 216, and communication hardware 218. The input and output 212 hardware may include a monitor, touch screen, speaker, camera, microphone, keyboard, mouse, printer, facsimile machine, and other similar hardware for interacting with a human user. The processor 214 may be any type of electronic processing hardware, such as central processing unit, programmable controller, field programmable gate array, microprocessor, multicore processor, etc. The memory 214 may include both volatile and noon-volatile memory. The memory 216 may include a non-transitory computer readable medium. The processor 214 and memory 216 together may be considered processing circuitry configured to perform processing operations such as executing instructions stored in the memory 216. The communication hardware 218 may include wireless communication hardware for wireless local area network communications and device to device communication, ports for wired communication, optical terminals for fiber optic communication, and other similar hardware.

The client device 220 may include similar hardware as the user device 210. The client device 220 may be a personal computer, smartphone, service, group of processing devices, etc. The client device 220 may include a processor 224, a memory 226, and communication hardware 228 respectively similar to the processor 214, the memory 216, and the communication hardware 218 of the user device 210.

The client device 220 and the user device 210 may communicate over wireless local area network, cell phone network, device to device communication, wired communication, fiber optic communication or any other form of electronic communication. The operations described with relation to FIGS. 1 and 3-6 may be performed by the user device 210.

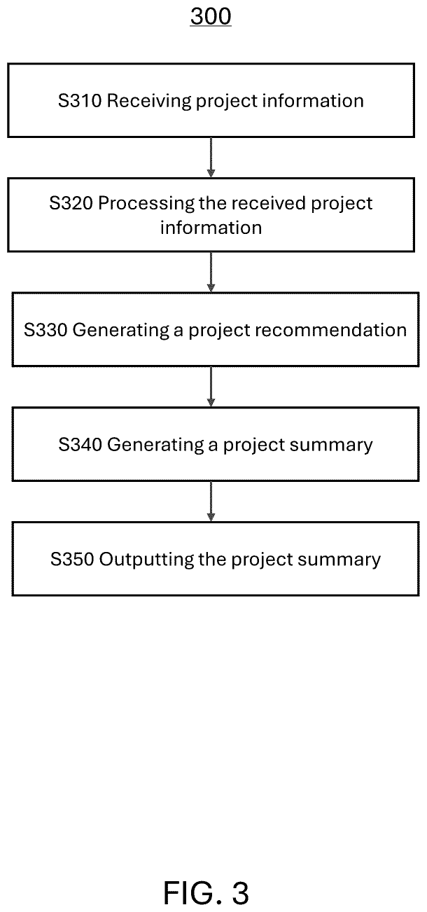

FIG. 3 illustrates a flow diagram 300 of operations performed by the apparatus to extract technical parameters and functional characteristics from project information. The apparatus to extract device parameters from project information may be the user device 210.

At S 310, the user device 210 may receive project information. The project information may be in the form of documents, emails, schematics, a string, and/or other electronic information. The user device 210 may receive the project information from the client device 220 or from a memory, or from another location.

At S320, the user device 210 may perform processing of the received project information. The processing may include using a large language model to evaluate strings of natural language to determine technical parameters and functional characteristics for one or more projects to be performed on building access hardware. For example, projects may include, installing building access hardware (elevators, escalators, moving walkways, access gates, garage door or other doors, etc.) or servicing building access hardware. The building access hardware may allow people to access or more easily travel through a building using powered mechanical hardware.

The processing may include determining which building access hardware for which installation or services are being requested, determining parameters for the installation or services to the building access hardware, determining a location of the building, and determining regulations related to the building access hardware in the building. The processing may also include identifying candidate projects based on the parameters. For example, the user device 210 may match parameters extracted from the project information to installation or services which the user is able to perform. For example, if the user is a representative from a company which has elevators which can be installed in elevator shafts with first dimensions, and the client request includes an elevator shaft with the first dimensions, the candidate projects would include the elevators which the user can install.

At S330, the user device 210 may generate the project recommendation including at least one candidate project. The project recommendation may include the technical parameters and functional characteristics for each candidate project and a comparison to the technical parameters and functional characteristics from the project information. The user device may select the candidate projects based on the technical parameters and functional characteristics of the candidate project matching the technical parameters and functional characteristics of the project information. For example, an elevator may be installed in an elevator shaft having a first range of dimensions, if the elevator shaft dimensions included in the project information is within the first range that parameter is met. As another example, the project request parameters may include a maximum speed of at least 2 m/s, if the technical parameters for an elevator model includes a maximum steed of 2.5 m/s the technical parameter is met. The project recommendations may be displayed to a user for review and selection.

At S340, the user device 210 may generate a project summary. The project summary may be included in a tendering document tendering an offer of a project including installation and/or services. The project summary may include a selected candidate project (selected by either the user or the user device 210). The project summary may be an electronic document such as a Microsoft Word document, an email, or another form of electronic file, or a printed document.

At S350, the user device 210 may output the project summary by sending the project summary to the user, the client, or a printer for printing. The project summary may be sent to the user or client via electronic communication such as email or document transfer. The project summary may be output based on an input from the user such as through a print command, email send command, a document transfer command, or other similar computer command received through the input and output hardware 212. The use device 210 may communicate with the client device 220 or through a network send electronic information to the client device 220 to output the project summary to the client. After the project summary is output the project summary and project information as well as candidate projects and user input may be used as feedback for training the large language model or other machine learning model used to extract the technical parameters and functional characteristics for improved future performance.

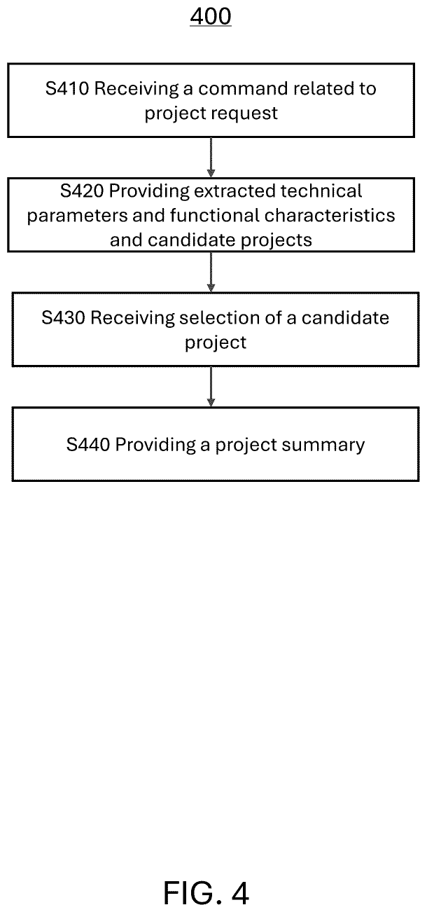

FIG. 4 illustrates a flow diagram 400 of operations performed by the user interface apparatus. The user device 210 may be the user interface apparatus.

At S410, the user device 210 may receive a command related to a request. The command may include an extraction command provided with documents for technical parameters and functional characteristics to be extracted from. The command may also include a command to send a request for documents to the client device 220.

At S420, the user device 210 may provide extracted technical parameters and functional characteristics and candidate projects to a user via a visual display or audio output. For example, the technical parameters and functional characteristics from the project information may be displayed along with the technical parameters and functional characteristics of each of the candidate projects so that a user can compare the candidate projects.

At S430, the user device 210 may receive a selection of a candidate project from the user via the input and output hardware 212. For example, the user may use a touch screen to select a candidate project. The user may also use voice commands received via a microphone, gestures perceived a command by the user device 210 using the camera, mouse or keyboard inputs, etc.

At S440, the user device may provide a project summary to the user via the input and output hardware 212. For example, the project summary may be displayed, output as audio, or transferred as an electronic document via email. The project document may also be provided to the client via the client device 220.

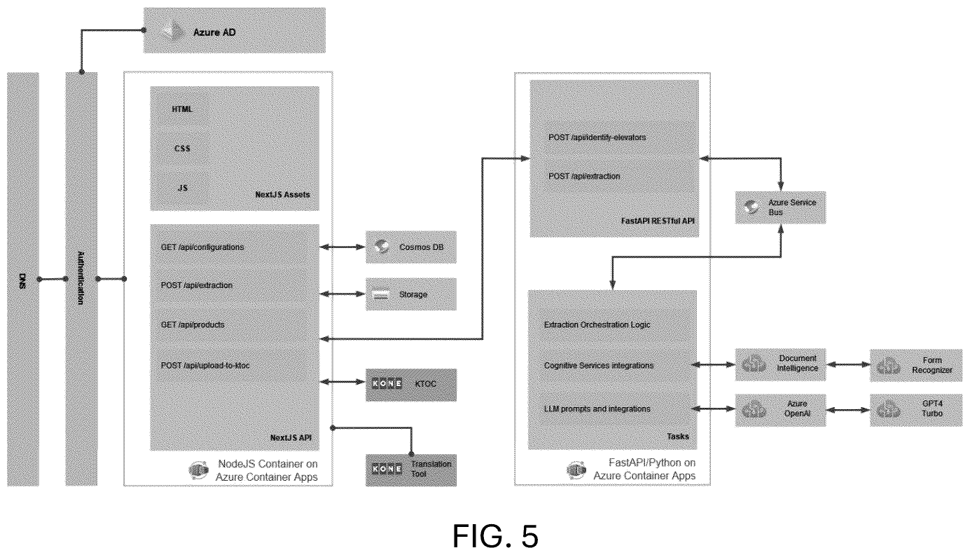

FIG. 5 illustrates a flow diagram showing an example flow of information in an apparatus. The apparatus may be the user device 210. A domain name system along with a system such as Microsoft Azure AD (active directory) can be used to log into a program for performing the operations of generating a project summary. The program may be NextJS API (next java script application program interface). The program may be used to manage an application for generating the project summary. The program may be a container on NodeJS (node java script) container on Azure container apps. The program may receive application configurations, post api extractions, get api products (including services which can be provided for the products), and post api uploads. The operations of the program may be made in communication with a cosmos database (e.g., an external data base), a storage (such as memory 216), a company server holding previous tendering documents (e.g., KTOC) and a Kone translation tool. The Kone translation tool is an example of a translation tool which translates documents, extracted information, and the user interface into different languages based on a detected language, a region, or a selection of the user. The program may be able to recognize text in different languages automatically to determine to perform the translation. The determination of the language may be made based on the source of a document (such as source location, or source client). The machine learning may be performed in one language (e.g., English) and all documents and information by be translated to that language before being processed by the machine learning algorithm, then the results may be translated back into the user's language. In this way, any user who speaks any language included in the translation tool can fully utilize the machine learning algorithm. For example, a user in France who speaks French may input documents which are in French. The translation tool may translate the French documents into English, then the LLM may use the English translation of the documents to extract the technical parameters and functional characteristics and generate the project recommendations. Then the technical parameters and functional characteristics and project recommendations may be translated into French and displayed in French to the user. The storage may provide the electronic documents which are the project information to the program. The program may be an extension of a program such as Salesforce which can generate tendering documents.

The NodeJS may communicate with a FASTAPI (fast application program interface) python on Azure container apps. The FASTAPI may post api identify elevators, where building access hardware for candidate projects is provided. The FASTAPI may post api extraction where technical parameters and functional characteristics are provided. Using an Azure service bus the FASTAPI may extract orchestration logic for performing technical parameter extraction from the project information. The FASTAPI may perform cognitive services integrations with a document intelligence including a form recognizer. The document intelligence and form recognizer may function to determine a type of document so the large language model can more easily extract technical parameters and functional characteristics. For example, the form recognizer may recognize a document as being a natural language summary of requested services, a schematic, a communication (e.g., email or string of messages), or another type of document. The FASTAPI may also perform LLM (large language model) prompts and integrations suing a Large Language Model such as Azure Open AI with GPT4 Turbo. The LLM prompt and integrations may extract the technical parameters and functional characteristics from the project information based on the identification of the form of the documents (or files, or strings of data).

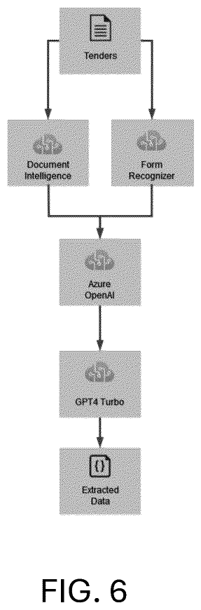

FIG. 6 illustrates a flow diagram showing an example flow of information in extracting parameters from tenders. The extraction of data from the tenders may be used for training the large language model. The tenders may be provided to the document intelligence and form recognizers to recognize the form of the tenders. After the form type is recognized, the artificial intelligence may analyze the documents using Azure OpenAI and GPT4 turbo or other similar artificial intelligence programs to extract data for training the AI. This same process can be performed with information related to the tenders such as project information and user selections. Thus, the AI can be trained using existing documents related to tenders for building access hardware.

Various embodiments described herein may be implemented in a computer-readable medium using, for example, software, hardware, or some combination thereof. For a hardware implementation, the embodiments described herein may be implemented within one or more of Application Specific Integrated Circuits (ASICs), Digital Signal Processors (DSPs), Digital Signal Processing Devices (DSPDs), Programmable Logic Devices (PLDs), Field Programmable Gate Arrays (FPGAs), processors, controllers, micro-controllers, microprocessors, other electronic units designed to perform the functions described herein, or a selective combination thereof. In some cases, such embodiments are implemented by the controller. That is, the controller is a hardware-embedded processor executing the appropriate algorithms (e.g., flowcharts) for performing the described functions and thus has sufficient structure.

For a software implementation, the embodiments such as procedures and functions may be implemented together with separate software modules each of which performs at least one of functions and operations. The software codes can be implemented with a software application written in any suitable programming language. Also, the software codes may be stored in the memory and executed by the controller. Thus, the components shown in the drawings have sufficient structure to implement the appropriate algorithms for performing the described functions.

The present invention encompasses various modifications to each of the examples and embodiments discussed herein. According to the invention, one or more features described above in one embodiment or example can be equally applied to another embodiment or example described above. The features of one or more embodiments or examples described above can be combined into each of the embodiments or examples described above. Any full or partial combination of one or more embodiment or examples of the invention is also part of the invention.

What is claimed is:

1. An apparatus for extracting technical parameters and functional characteristics from project information, the apparatus comprising:
processing circuitry configured to:
receive project information related to a requested project for a building access hardware, the project information including technical parameters and functional characteristics of the requested project;
process the received project information using a machine learning model to extract the technical parameters and functional characteristics from natural language in the received project information; and
generate a project recommendation based on the extracted technical parameters and functional characteristics, the project recommendation including one or more candidate projects related to the building access hardware, the project recommendations based on the technical parameters and functional characteristics to the building access hardware included in the project information.

2. The apparatus of claim 1, wherein the processing circuitry is further configured to:
generate a project summary based on the project recommendation, the project summary including one of the one or more candidate projects related to the building access hardware.

3. The apparatus of claim 2, wherein the machine learning model is trained on a library of previous project information and previous project summaries related to building access hardware.

4. The apparatus of claim 3, wherein the processing circuitry is further configured to:
update the machine learning model by updating the previous project information with the project information, updating the previous project summaries with the project summary, and training the machine learning model using the updated previous project information and the updated previous project summaries.

5. The apparatus of claim 2, wherein the processing circuitry is further configured to:
receive input form a user of the apparatus, wherein the generating the project summary is further based on the input from the user.

6. The apparatus of claim 5, wherein the input from the user includes a selection of one of the one or more candidate projects related to the building access hardware.

7. The apparatus of claim 1, wherein the building access hardware is one of an escalator, a moving walkway, an elevator, automatic doors, and an access gate.

8. The apparatus of claim 1, wherein the technical parameters and functional characteristics of the requested project include at least one of a size dimension, a weight capacity, a speed, and an access type of the building access hardware.

9. The apparatus of claim 1, wherein the project information includes a building schematic, and the technical parameters and functional characteristics are extracted from the building schematic.

10. The apparatus of claim 1, wherein the project recommendation is one of an installation of a first building access hardware, refurbishing a second building access hardware, or updating a third building access hardware.

11. The apparatus of claim 1, wherein the project summary includes one of the one or more candidate projects and the technical parameters and functional characteristics are satisfied by the one of the one or more candidate projects.

12. The apparatus of claim 1, wherein the machine learning model is a large language model trained on natural language to recognize technical parameters and functional characteristics for building access hardware.

13. The apparatus of claim 1, wherein
the one or more candidate projects are extracted from a database including a plurality of candidate projects,
each of the candidate projects are associated with a plurality of design constraints, and
the project recommendations are generated by comparing the design constraints of each of the candidate projects with the technical parameters and functional characteristics of the project information.

14. A user interface apparatus comprising:
a user input and output interface; and
processing circuitry configured to:
receive project information related to a requested project for a building access hardware, the project information including technical parameters and functional characteristics of the requested project;
extract the technical parameters and functional characteristics of the requested project to the building access hardware;
generate a project recommendation list based on the extracted technical parameters and functional characteristics, the project recommendation list including one or more candidate projects related to the building access hardware, the project recommendations based on the technical parameters and functional characteristics included in the project information;
provide the project recommendation list to a user via the user input and output interface;
receive a selection of one of the one or more candidate projects related to the building access hardware from the user via the user input and output configuration; and
generate a project summary based on the selected one of the one or more candidate projects related to the building access hardware.

15. The apparatus of claim 14, wherein the user input and output interface includes a graphical user interface, and providing the project recommendation list includes displaying the project recommendation list on the graphical user interface.

16. The apparatus of claim 15, wherein the recommendation list includes a plurality of candidate projects related to the building access hardware and the plurality of candidate projects related to the building access hardware are displayed according to a ranking determined based on technical parameters and functional characteristics.

17. The apparatus of claim 16, wherein the ranking is further determined based on at least one of ecological impact, energy efficiency, safety, and reliability.

18. The apparatus of claim 14, wherein the technical parameters and functional characteristics of the requested project for the building access hardware are extracted using a machine learning model.

19. The apparatus of claim 14, wherein the building access hardware is one of an escalator, an elevator, and an access gate.

20. An apparatus for extracting technical parameters and functional characteristics from project information, the apparatus comprising:
processing circuitry configured to:
receive project information related to a requested project for a building access hardware, the project information including technical parameters and functional characteristics of the requested project;
process the received project information using a machine learning model to extract the technical parameters and functional characteristics from natural language in the received project information, wherein the machine learning model is trained on a library of previous project information and previous project summaries related to building access hardware;
generate a project summary based on the extracted technical parameters and functional characteristics, the project summary including one of the one or more candidate projects related to the building access hardware; and
update the machine learning model by updating the previous project information with the project information, updating the previous project summaries with the project summary, and training the machine learning model using the updated previous project information and the updated previous project summaries.
